(19) United States
(12) Patent Application Publication
(10) Pub. No.: US 2010/0052929 A1
(43) Pub. Date: Mar. 4, 2010

(54) High voltage proximity warning alarm system

(76) Inventors: Dave Jackett, Fenelon Falls (CA); Brian Jackett, Fenelon Falls (CA); Stan Szablewski, Lindsay (CA); Andrew Schmidt, Woodville (CA); Ross Price, Fenelon Falls (CA); Mike Peart, Keene (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 12/461,741

(22) Filed: Aug. 21, 2009

Related U.S. Application Data
(60) Provisional application No. 61/136,253, filed on Aug. 21, 2008.

(51) Int. Cl. G08B 21/00

(52) U.S. Cl. 340/660

(57) ABSTRACT

A high voltage proximity warning system, precise, easy to use, easy to install, rugged and weatherproof, has a control panel which is located in the cab of an excavator, other heavy equipment or vehicle, such that it is readily accessible to the operator during equipment operation and is connected to one or more strategically located sensor antenna(s). The control panel is designed to be used with or without gloves, in a position where it is readily visible. It is electrically connected to the equipment's power source. At least one high voltage proximity sensor is mountable to the vehicle and is in wired or wireless communication with the control panel.

### RELATED APPLICATION

This application claims the benefit under 35 U.S.C. 119(e) to U.S. Provisional Application Ser. No. 61/136,253 entitled “High Voltage Proximity Warning Alarm System”, filed Aug. 21, 2008.

### FIELD OF THE INVENTION

This invention relates to a high voltage proximity warning alarm system particularly useful when installed on heavy equipment.

### BACKGROUND OF THE INVENTION

Contact of high power lines by vehicles continues to be a safety concern for equipment operators as well as persons coming to their rescue. In addition to the dangers of contact with high voltage power lines, damage to the power lines also causes inconvenience to users of electricity and increased economic costs to power companies which supply electricity and maintain the electrical distribution systems.

### SUMMARY OF THE INVENTION

The present invention is directed to a high voltage proximity warning system. High voltage is considered to be any voltage that can cause injury or harm to a person. It is an object of this invention to provide a warning device that senses a proximity to high voltage power lines. The sensor provides enhanced safety to operators of heavy equipment by sensing a proximity of a vehicle including heavy equipment and any other vehicle that may come in contact with a high voltage power line during regular work routines.

In one aspect, the present invention resides in high voltage proximity warning alarm system comprising: a controller having a user interface and at least one audio and/or visual warning indicator; and one or more proximity sensors in electrical communication with the controller by at least one cable, the one or more proximity sensors capable of sensing a proximity to high voltage. More preferably, the one or more proximity sensors are in wireless communication with the controller.

In another aspect, the present invention resides in a high voltage proximity warning alarm system comprising a controller and at least one voltage proximity sensor mountable to a vehicle and in communication with the controller, wherein: the controller has a user interface and at least one warning indicator which alerts a user when a voltage sensed by the at least one proximity sensor is above a user specified threshold value and each of the at least one voltage proximity sensor has a sensor housing having a front surface and a back surface, the front surface having a sensor plate connected to a voltage sensor positioned in the housing, and the sensor housing having side surfaces connecting the front surface to the back surface, the side surfaces being chamfered as sloping outwardly from the front surface to the back surface when the sensor housing is viewed from a side view, the back surface being planar so as to be mountable flat against a planar surface of the vehicle.

In yet another aspect, the present invention resides in a high voltage proximity warning alarm system comprising a controller and at least one voltage proximity sensor mountable to a vehicle and in communication with the controller, wherein: the controller has a user interface and at least one warning indicator which alerts a user when a voltage sensed by the at least one proximity sensor is above a user specified threshold value and each of the at least one voltage proximity sensor has a sensor housing having a front surface and a back surface, the front surface having a sensor plate connected to a voltage sensor positioned in the housing, and the sensor housing having side surfaces connecting the front surface to the back surface, the side surfaces being chamfered as sloping outwardly from the front surface to the back surface when the sensor housing is viewed from a side view, the back surface being planar so as to be mountable flat against a planar top surface of a sensor mounting plate which is fixed to a flat surface of the vehicle.

Further and other features of the invention will be apparent to those skilled in the art from the following detailed description of the embodiments thereof.

### BRIEF DESCRIPTION OF THE DRAWINGS

Reference may now be had to the following detailed description taken together with the accompanying drawings in which:

FIG. 1 shows a high voltage proximity warning system in accordance with one embodiment of the present invention;

FIG. 2 shows a control box of the high voltage proximity warning system shown in FIG. 1;

FIG. 3 shows a sensor of the high voltage proximity warning system shown in FIG. 1;

FIG. 4 shows a bottom side of the sensor shown in FIG. 3;

FIG. 5 shows a block diagram of the high voltage proximity warning system;

FIG. 6 shows a block diagram of a high voltage proximity warning system with wireless communicating components;

FIG. 7 shows a high voltage proximity warning system in accordance with another embodiment of the present invention;

FIG. 8 shows a voltage sensor and sensor mounting plate as shown in the high voltage proximity warning system in FIG. 7;

FIG. 9 shows a cross-section of the voltage sensor housing and sensor mounting plate shown in FIG. 7 through a plane extending vertically downward through cross-sectional line X-X;

FIG. 10 shows the voltage sensor housing shown in FIG. 8;

FIG. 11 shows a back surface of the voltage sensor housing shown in FIG. 10;

FIG. 12 shows the sensor mounting plate as shown in FIG. 8;

FIG. 13 shows a wireless high voltage sensor in accordance with another embodiment of the present invention;

FIG. 14 shows the controller in FIG. 7 with a mounting base in accordance with a preferred embodiment; and

FIG. 15 shows a backhoe with a wireless voltage proximity warning system connected thereto.

### DETAILED DESCRIPTION OF THE PREFERRED EMBODIMENTS

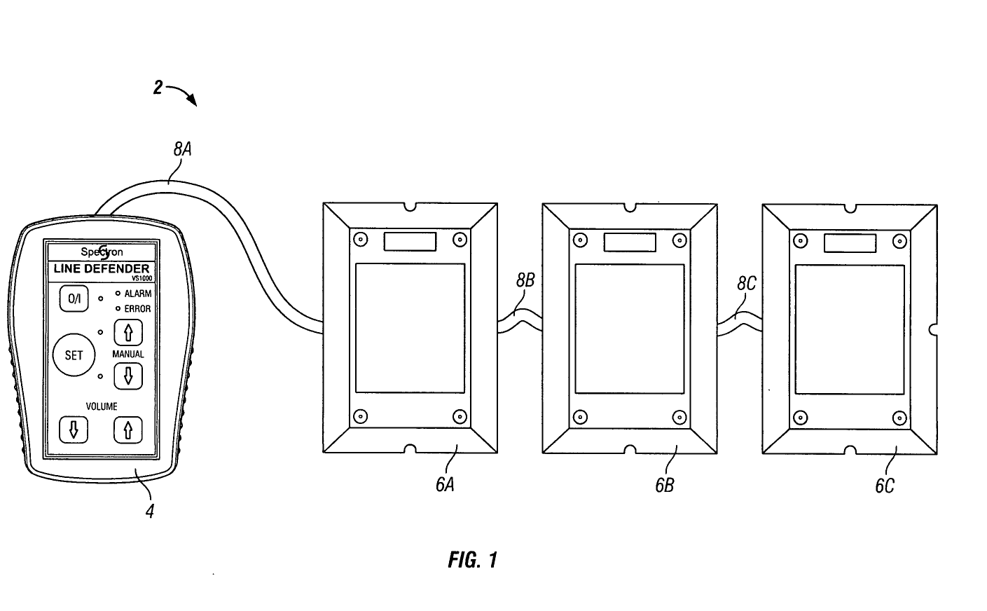

FIG. 1 shows a high voltage proximity warning system 2 in accordance with one embodiment of the present invention. The system 2 has a controller 4 electrically connected to three sensors 6A, 6B and 6C. While other embodiments may include more or less than three sensors, the embodiment shown in FIG. 1 has three sensors. The controller 4 is connected to the first sensor 6A by cable 8A, the first sensor 6A is connected to the second sensor 6B by cable 8B, and the second sensor 6B is connected to the third sensor 6C by cable 8C.

In use, the controller 4 is selectively positioned in an operational, audio and visual nearness to heavy equipment or vehicle operator in the heavy equipment vehicle cab, and the electrical field proximity sensor 6A, 6B are fixed to the heavy equipment to sense high voltage.

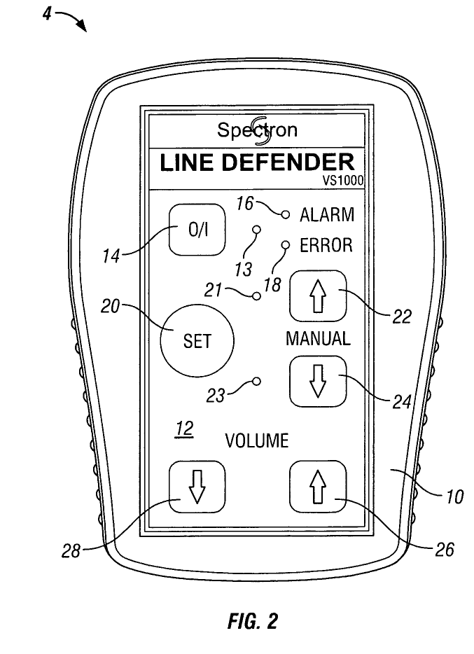

The controller 4 is shown in detail in FIG. 2. The controller 4 has a housing 10 that is constructed to be weatherproof and to resist entry of water to protect the active electronic circuitry contained within the housing.

A user interface portion 12 is provided on a top side of the controller 4. The user interface portion 12 has an on/off latching push button 14. A green LED power indicating light 13 is positioned to a right side of the on/off push button 14. The green LED power indicating light 13 lights up when the controller is on to inform the user.

The user interface portion 12 also has an alarm LED 16. The alarm LED 16 lights up in red if an alarm condition has been met, for example an antenna is in a predetermined proximity to high voltage cables.

An error LED 18 is also provided on a user interface portion 12. The error LED 18 lights up when an error condition has been met, for example a cable connecting the controller 4 to one or more of the sensor 6 or a cable between the sensors 6A, 6B, or 6C is faulty or disconnected.

The user interface portion 12 has a set push button 20 used to “set” the threshold sensitivity of the sensors in terms of sensing proximity of a source of high voltage to the sensor. A manual sensitivity increase button 22, and a manual sensitivity decrease button 24 are also provided on the user interface portion 12. The manual sensitivity increase button 22 is used to increase the sensitivity threshold. The manual sensitivity decrease button 24 is used to decrease the threshold sensitivity of the sensors.

The manual increase button 22 has an associated red/green bicolour LED 21. The manual decrease button 24 has an associated red/green bicolour LED 23. The green LED indicates that the depressed up or down manual push button is increasing or decreasing the threshold, respectively. The red LEDs indicate that the end of a given adjustment range for manual control has been reached and thus can not be further increased or decreased. Once the user is satisfied with the threshold adjustment, they commence use of their heavy equipment.

The user interface portion 12 also has a volume increase push button 26 and a volume decrease push button 28. A speaker (not shown) is provided within the housing 10 as a audio alarm signal when an alarm condition has been met, for example the sensors 6A, 6B or 6C are in a threshold proximity high voltage power lines. The volume of the audio alarm can be set using the volume increase button 26 or volume decrease button 28.

The audio alarm is designed such that it can be adjusted to be heard above the loud background noise that may be present in heavy equipment or other vehicle environments.

Each of the push buttons provided on the user interface portion 12 are operable conveniently by a user with or without gloved hands. The controller 4 can be provided near the operator of heavy equipment in a location that is readily visible and audible and easily connectable electrically to the proximity sensors 6A, 6B and 6C.

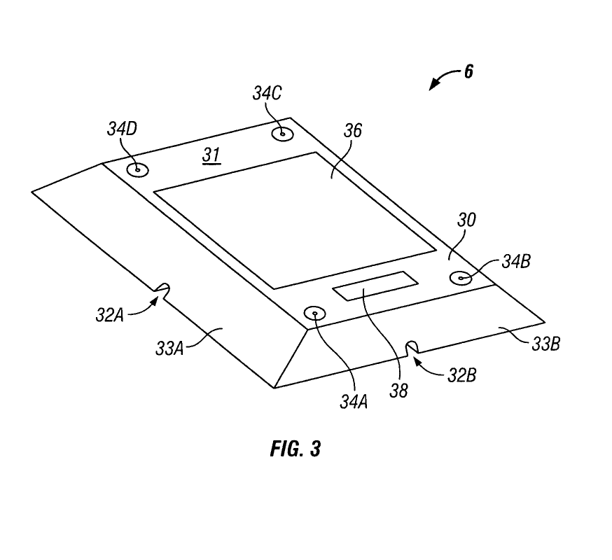

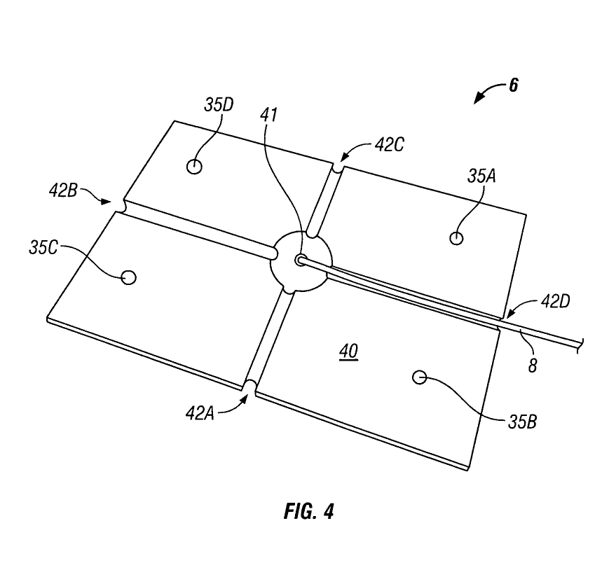

A sensor 6 is shown in perspective view in FIG. 3. The sensor 6 has a sensor housing 30. The sensor housing 30 has a front surface 31 and a back surface 40, shown in FIG. 4. The sensor housing 30 has chamfered edges 33A and 33B which slant outwardly from the front surface 31 to the back surface 40 when the sensor housing 30 is viewed from a side view. Similar chamfered edges 33C and 33D (not shown) are provided on the other two sides of the sensor housing 30. The chamfered edges 33A, 33B, 33C and 33D advantageously prevent the housing from catching on branches or debris which may be encountered when using heavy equipment to which the sensor is attached. Preferably, the sensor housing 30 is made of a durable material such as ultra high modular weight polyethylene (“UHMW”) and powder coated steel, which protect the sensor from physical damage and resist damage caused by weather conditions. The sensor housing 30 could also be made of polycarbonate or acrylic material.

The sensor housing 30 has wire channels 32A, 32B provided so that a wire connecting the sensor to the controller 4 or an additional sensor 6 fits within the channel 32A or 32B, so that the sensor housing 30 can be mounted flush against a planar surface of the vehicle or heavy equipment.

As shown in FIG. 3, the sensor plate housing is mountable to the vehicle or heavy equipment using mechanical mounting fasteners such as bolts 34A, 34B, 34C and 34D. The mounting fasteners 34A, 34B, 34C and 34D are fitted through respective bore holes 35A, 35B, 35C and 35D shown in FIG. 4.

A sensor plate 36 is provided on a top surface of the sensor housing 30. The sensor plate 36 and active circuitry provide precise detection of high voltage electricity lines. The sensitivity of voltage detection can be adjusted using the controller 4 as described above.

A name plate 38 is also provided on the top surface of the sensor housing 30.

FIG. 4 shows a bottom surface 40 of the sensor housing 30. Cable channels 42A, 42B, 42C and 42D are provided on the bottom surface 40 to provide space for a cable to run to an outer perimeter of the bottom surface 40 and facilitate a flush mounting of the sensor 6. As shown, cable 8 is positioned in channel 42D and passes through an orifice 41 through a middle of the back surface 40 to connect to a voltage sensor (not shown) positioned within the sensor housing 30.

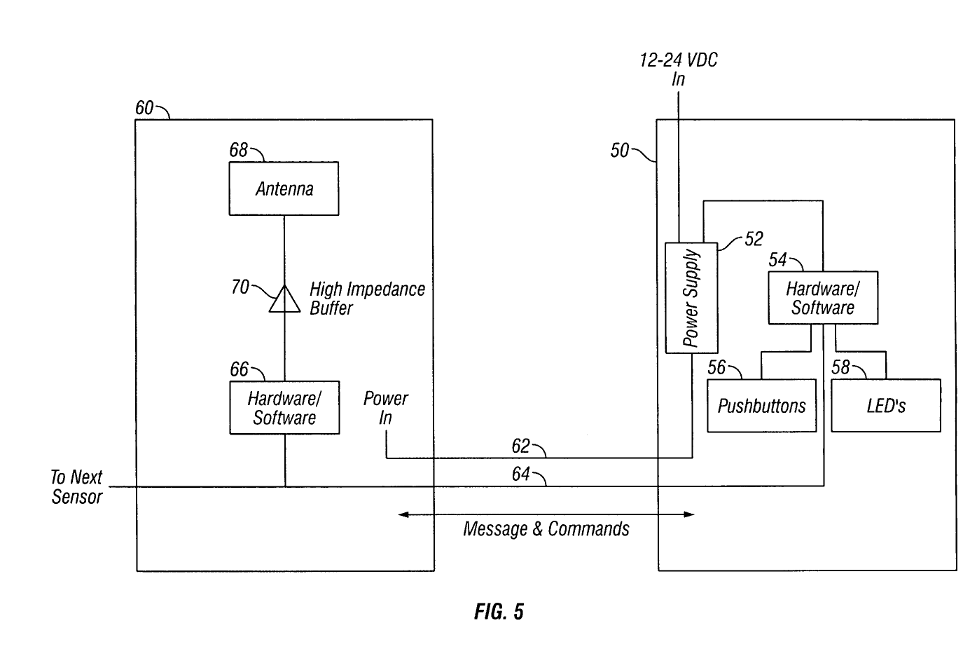

FIG. 5 shows a schematic block diagram of the sensor and control box including the interior components. The control box 50 has a power supply 52. The power supply 52 preferably is 12 to 24 volts direct current. The power supply 52 is connected to hardware/software 54. The hardware/software 54 receives inputs from pushbuttons 56, for example which are depressed by a user. The hardware/software 54 is connected to LEDs 58, which provide visual indication to the user in response to activation of the pushbuttons 56 through the software 54 and from output commands from the software in relation to inputs from a sensor 60.

The sensor 60 is connected to the control box 50 with power supply line 62 and a software communication line 64. The sensor has sensor hardware/software 66 which communicates with the control box hardware/software 54 via the software communication line 64. The sensor 60 has an antenna 68 which is capable of sensing the proximity to high voltage. The antenna 68 is connected to the sensor hardware/software 66. The sensor hardware/software 66 receives inputs from the antenna 68 with respect to a voltage sensing and communicates the inputs via outputs to the control box hardware/software 54 via the software communication line 64. A high impedance buffer 70 is provided between the antenna 68 and sensor hardware/software 66. The high impedance buffer 70 provides a stable signal for the sensor hardware/software 66. It does this by effectively isolating the signal on the antenna from any loading effect that the hardware/software 66 might otherwise have on this signal.

As shown in FIG. 5, the sensor 60 can be connected in series to an additional sensor via a continuation of the software communication line 64. It is appreciated that an extension of the power supply line 62 can also be provided for additional sensors.

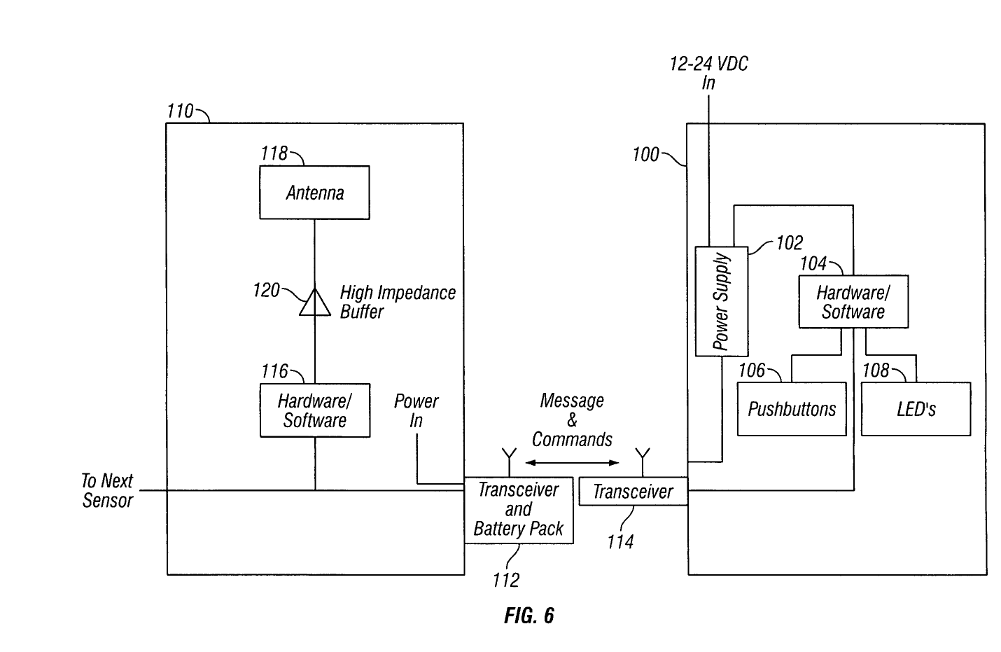

FIG. 6 shows a similar block diagram as shown in FIG. 5. In FIG. 6, the control box 100 has a power supply 102 preferably having an input voltage of 12 to 24 volts DC. The power supply 102 is connected to control box hardware/software 104 to provide power thereto. Pushbuttons 106 are provided on the control box 100 and are connected to the control box hardware/software 104. Pushbuttons 106 are actuated by a user to effect commands which are in turn inputted to the hardware/software 104. The hardware/software 104 communicates to the user via visual LEDs 108 in response to the user actuation of the pushbuttons 106. The hardware/software also communicates via LEDs 108 to indicate conditions communicated from a sensor 110. The sensor 110 has a transceiver and battery pack 112 which sends wireless signals which are received by a control box transceiver 114, and vice versa. As such, the sensor transceiver 112 and the control box transceiver 114 send and receive signals so as to have bilateral communication capabilities.

The sensor 110 is equipped with hardware/software 116 which is in turn connected to an antenna 118. The antenna 118 senses proximity to a source of high voltage and communicates to the sensor hardware/software 116. The hardware/software 116 interprets the signals received from the antenna 118 and communicates via transceiver 112 to the control box transceiver 114 and connected control box hardware/software 104.

A high impedance buffer 120 is provided between the antenna 118 and the sensor hardware/software 116. The high impedance buffer 120 provides a stable signal for the sensor hardware/software 116. It does this by effectively isolating the signal on the antenna from any loading effect that the hardware/software 116 might otherwise have on this signal.

By the construction shown in FIG. 6, the control box 100 and sensor 110 can cooperate to communicate to a user when the sensor 110, which is attached to heavy equipment, is in a specified proximity to high voltage to sound an alarm warning the user.

It is also appreciated that further sensors, similar to sensor 110, could be attached to the heavy equipment and similarly communicate with the control box transceiver 114 via sensor transceivers. Additional sensors are not shown in FIG. 6.

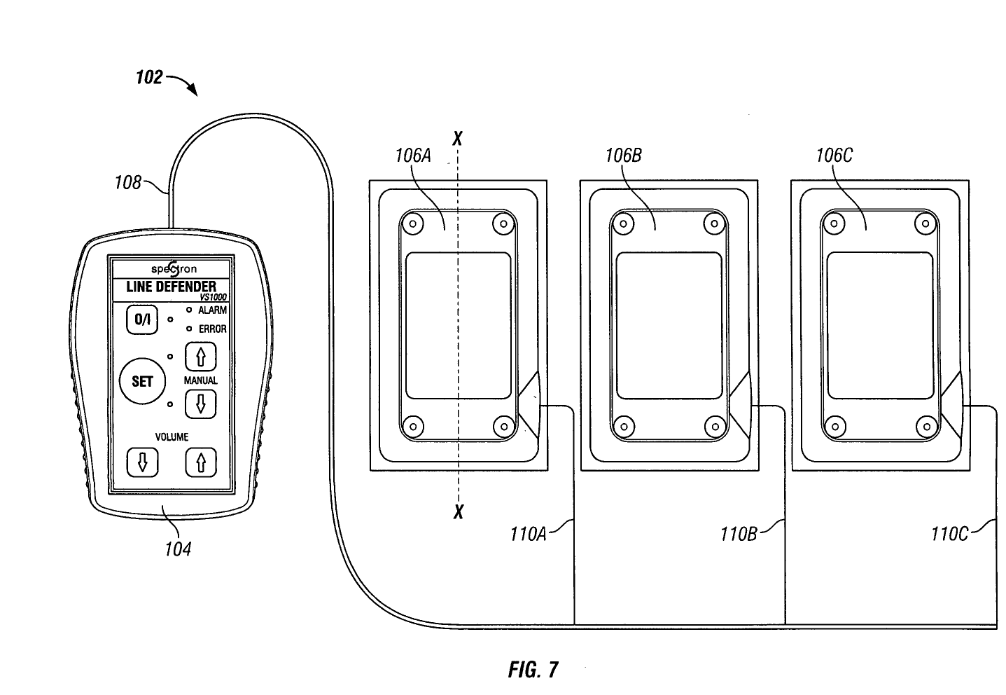

FIG. 7 shows a high voltage proximity warning system 102 in accordance with another embodiment of the present invention. The high voltage proximity warning system 102 has a controller 104 connected to the sensors 106A, 106B and 106C by a main cable 108 and respective lead cables 110A, 110B and 110C. It is appreciated that more or less than three sensors could be connected in the high voltage proximity warning system 102.

The controller 104 is similar in design to the controller 4 shown in the high voltage proximity warning system 2 of FIG. 1. The controller of 104 has similar features and operates in a similar manner as the controller 4 previously described.

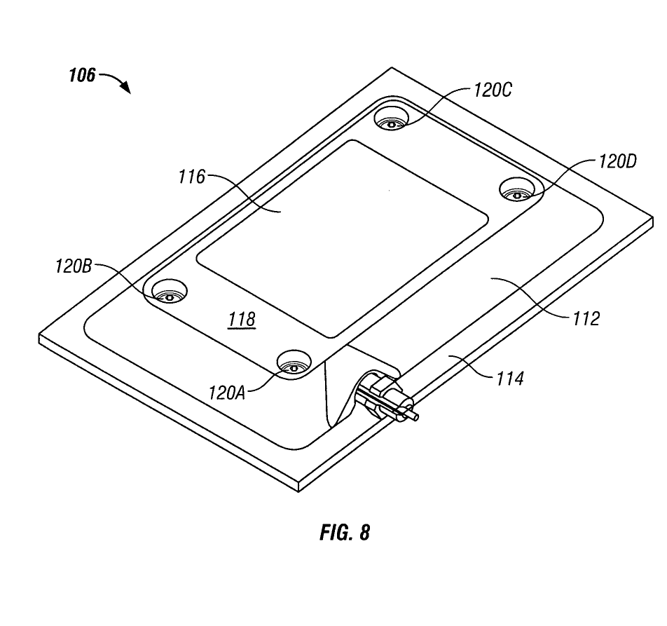

FIG. 8 shows a sensor 106 having a voltage sensor housing 112 and a sensor mounting plate 114. The voltage sensor housing 112 has a sensor plate 116 on a top surface 118 of the voltage sensor housing 112. The voltage sensor housing 112 is mounted to the sensor mounting plate 114 by threaded mechanical fasteners or bolts 120A, 120B, 120C, and 120D. The voltage sensor housing 112 is preferably made of UHMW, powder coated steel, polycarbonate or acrylic.

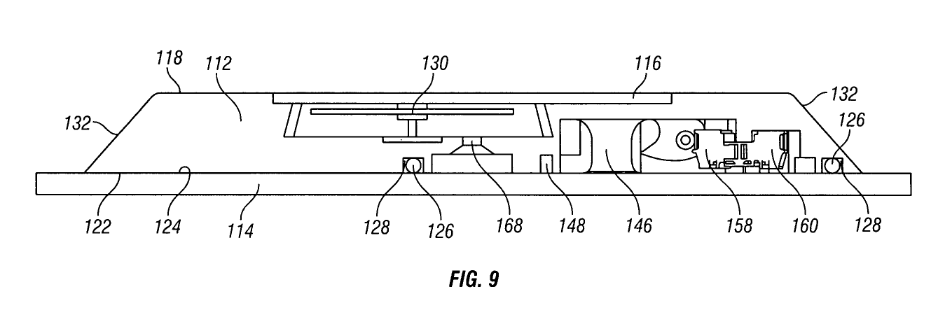

FIG. 9 shows the voltage sensor housing 112 and sensor mounting plate 114 in cross-sectional view taken along a plane through cross-sectional line X-X of sensor 106A shown in FIG. 7. As shown, a bottom surface 122 of the voltage sensor housing 112 is secured against a top surface 124 of the sensor mounting plate 114. An O-ring seal 126 is provided in a O-ring seal channel 128 to provide a seal against moisture and other material from entering into an inner portion of the sensor housing.

Also shown, a sensor 130 is provided inside the voltage sensor housing 112 and is connected to the sensor plate 116.

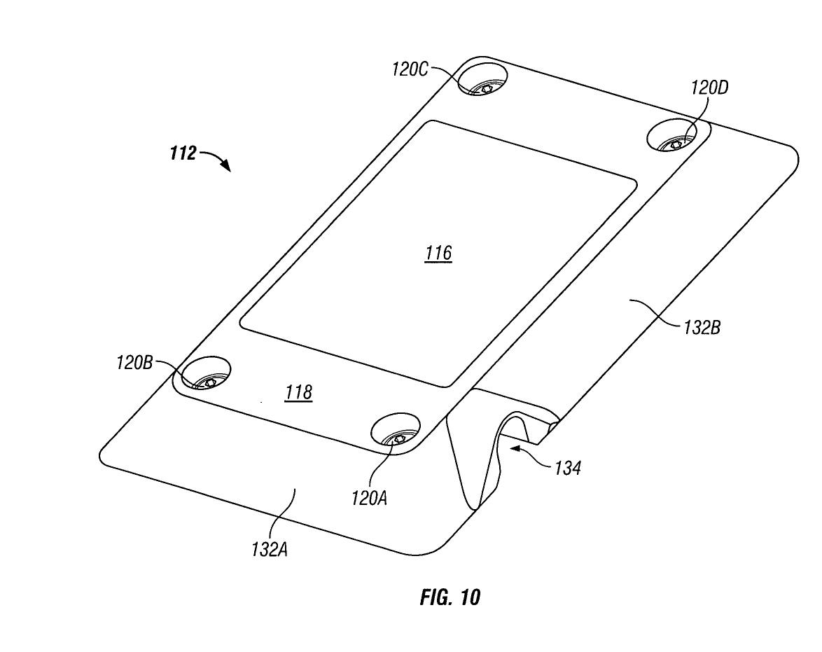

FIG. 10 shows the voltage sensor housing of FIG. 8. The voltage sensor housing 112 has chamfered edges 132 which extend outwardly from the top surface 118 to the bottom surface 122 when viewed in a side view of the voltage sensor housing 112 for example as shown in FIG. 9. As shown in FIG. 10, a wire mounting device port 134 is provided along chamfered edge 132B.

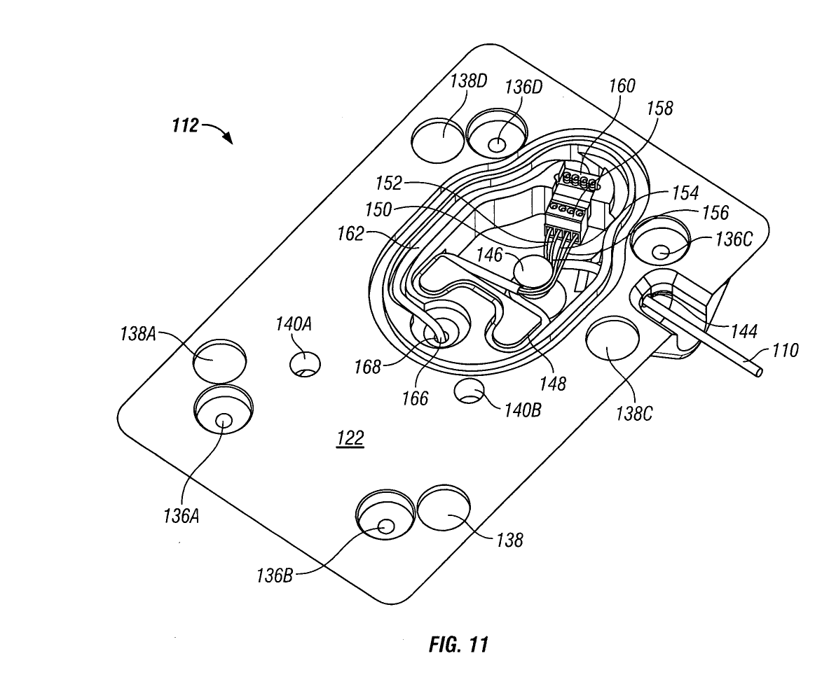

FIG. 11 shows the voltage sensor housing 112 from a back surface 122. The voltage sensor housing 112 has four mounting holes 136A, 136B, 136C, and 136D. The threaded fasteners 120A, 120B, 120C, and 120D shown in FIG. 8 are inserted through the mounting holes when fixing the voltage sensor housing 112 to the sensor mounting plate 114.

Also provided on the back surface 122 are four weld clearance embossments. The weld clearance embossments 138A, 138B, 138C, and 138D provide a spacing so that excess weld material does not prevent the flush mounting of the sensor housing 112 to the mounting plate 114.

Also shown, the back surface 122 has potting material vents 140A and 140B which are provided to fill an air space under the sensor plate with a potting material.

The lead wire 110 extends through an opening 144 through the port 134 and into an interior of the voltage sensor housing 112. An O-ring seal is provided between the opening 144 and the lead wire 110 to prevent moisture and other materials from entering into an inner cavity of the voltage sensor housing 112. As shown, the wire 110 extends around a strain relief post 146 and through a strain relieve groove 148. After passing through the strain relief groove 148, the wire 110 extends around the strain relief post 146 again in an opposite direction. The sensor wire comprises four wires which are a power wire 150, a ground wire 152, a first signal wire 154 and a second signal wire 156. The power wire 150, ground wire 152, first signal wire 154 and second signal wire 156 are each connected to a screw terminal block connector plug 158. The connector plug 158 is removeably insertable into a screw terminal block connector socket 160. A sensor wire 162 has a first end 164 connected to the connector socket 160. The sensor wire 162 has a second end 166 which passes through an orifice 168 to connect with the sensor 130, not shown in FIG. 11.

Connecting the lead wire 110 around the strain relief post 146 and through the strain relief groove advantageously protects the sensor cable 162 from being ripped out in the event that a force is exerted on the sensor housing 112. For example if the sensor housing is caught on a branch of a tree the lead wire 110 should break so that the sensor wire 162 is not damaged. Further, if the strain relief post 146 and strain relief groove 148 do not provide adequate protection against the sensor wire 162 from being pulled, the screw terminal block connector plug 158 will detach from the screw terminal block connector plug 164 if sufficient force is exerted by pulling on the lead wire 110. By preventing the sensor wire 162 from being ripped out, the repair in the event of damage to the sensor is made easier and less costly.

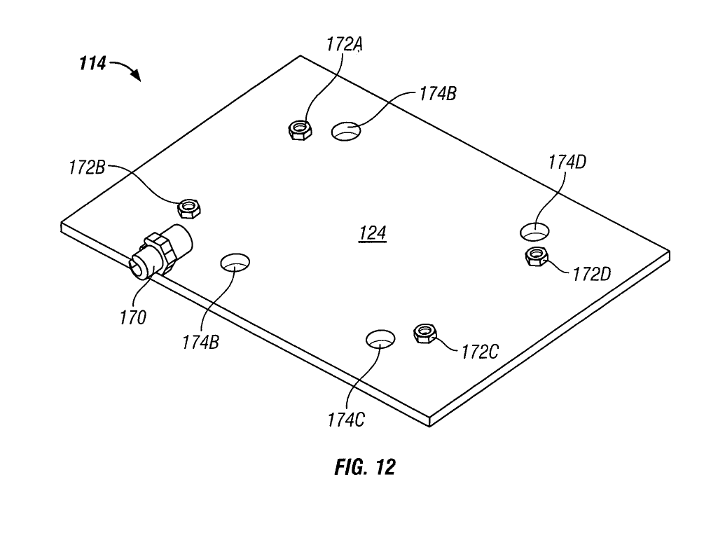

FIG. 12 shows the sensor mounting plate 114. The sensor mounting plate 114 has a lead wire mount 170 fixed to the top surface 124 of the sensor mounting plate 114. The lead wire mount 170 is provided to channel the lead wire 110 into the voltage sensor housing 112 for example as shown in FIG. 8.

The sensor mounting plate 114 has a four threaded nuts 172A, 172B, 172C, and 172D fixed to the top surface 124. The nuts 172A, 172B, 172C, and 172D are positioned to receive the bolts 120A, 120B, 120C, and 120D, respectively, to mount the voltage sensor housing 114 to the sensor mounting plate 114.

The sensor mounting plate 114 can be fixed to a vehicle by welding. Mounting bore holes 174A, 174B, 174C, and 174D are provided through the mounting plate 114 to enable welds to be made. As such welds on the sensor mounting plate 114 can be hidden by the sensor housing 112. Alternatively, the sensor mounting plate 114 could be fixed to the vehicle by inserting bolts through bore holes 174A, 174B, 174C, and 174D.

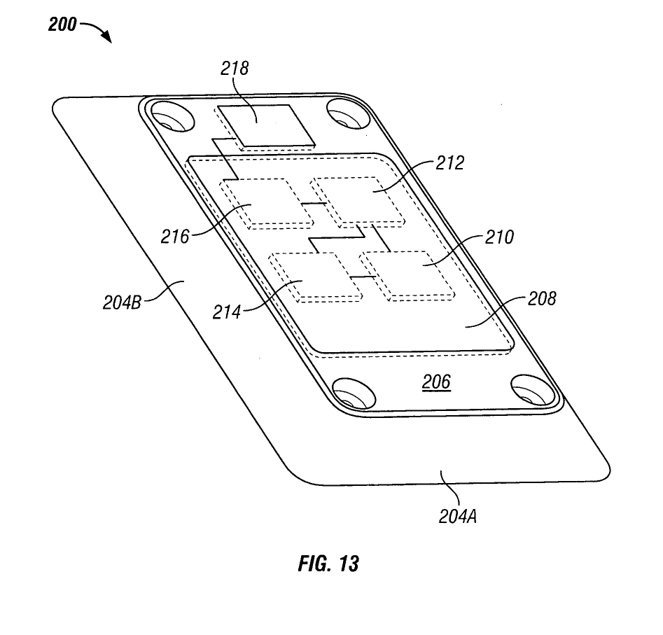

FIG. 13 shows a wireless high voltage sensor 200 in accordance with another embodiment of the present invention. The wireless high voltage sensor 200 comprises a voltage sensor housing 202 with chamfered edges 204A, 204B, 204C, and 204D.

A top surface 206 of the wireless high voltage sensor housing 202 has a sensor plate 208 thereon.

The sensor plate 208 is connected to a sensor control 210 positioned within the sensor housing 202. The sensor control is connected to a battery 212 provided inside the sensor housing 202 which provides power to the sensor control 210. Also connected to the sensor control 210 and to the battery 212 is a radio transmitter receiver device 214. The radio transmitter receiver device 214 is provided to communicate with a similar radio transmitter receiver device provided in a controller. As such, voltage readings sensed by the sensor plate are relayed to the sensor control and in turn to the radio transmitter/receiver device 214 for transmission to the controller. As such, the wireless high voltage sensor 200 can communicate with the controller to provide a warning in the event that a voltage above a threshold set voltage is sensed by the sensor plate 208.

A power control 216 is provided to charge the battery 212 as required. A power generation such a solar panel 218 is provided to generate power to charge the battery 212.

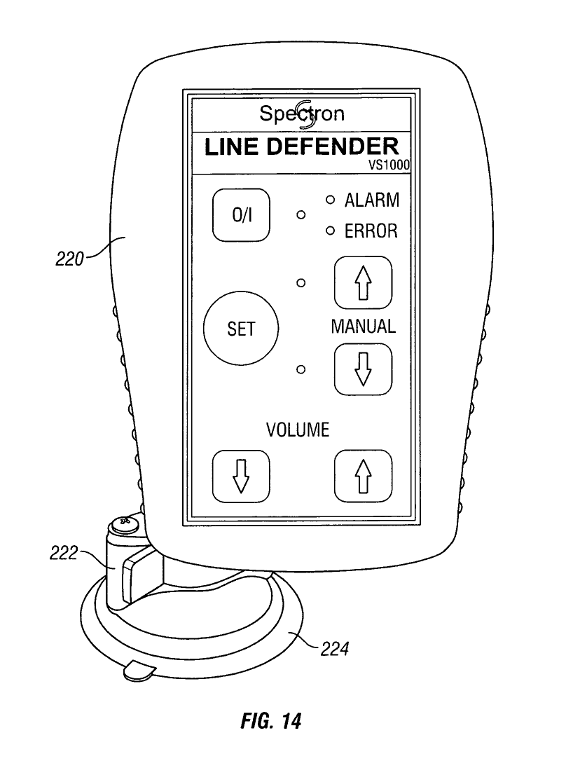

FIG. 14 shows the controller 220 with a mounting base 222. The mounting base 222 has a suction cup 224 which is used to fix the controller 220 to a surface of a vehicle in proximity to a user. It is also appreciated that the controller 220 can be connected to the vehicle by other means of connection including, but not limited to, bar mount, direct mount and double sided tape. The controller 220 is similar to the controller 104 shown in FIG. 7 except that the controller 220 has a controller radio transmitter/receiver device which is capable of wirelessly communicating with the sensor radio transmitter/receiver device 214 shown in FIG. 13.

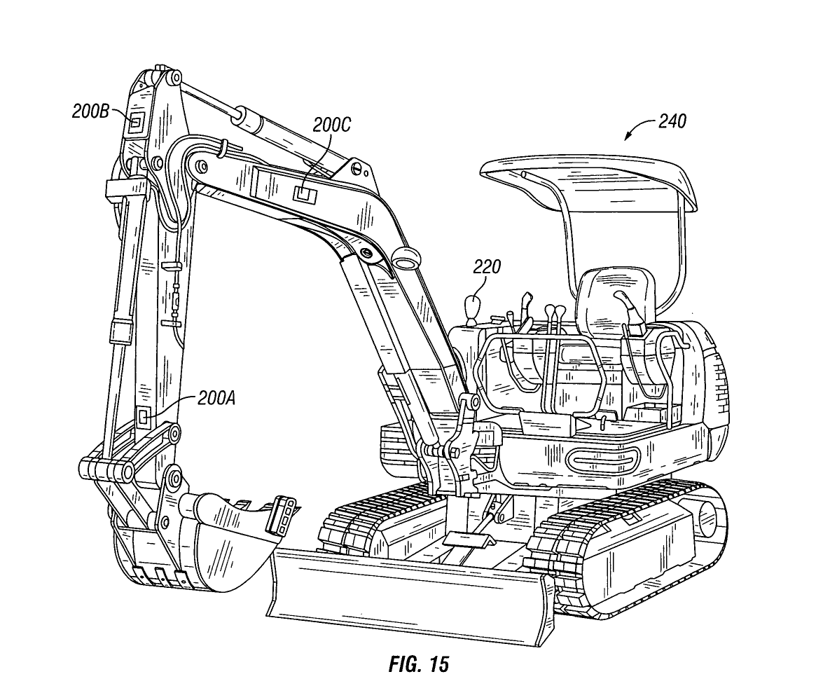

FIG. 15 shows a backhoe 240 with a controller 200 mounted in the cab, and three wireless voltage sensors 200A, 200B and 200C attached to the arm of the backhoe 240. It is understood that the voltage sensors 200A, 200B and 200C could be attached at alternate locations on the arm of the backhoe, or other parts of the backhoe including the cab. It is also to be understood that more or less than three voltage sensors could be attached, and could be wireless or connected by wires.

Although this disclosure has described and illustrated certain preferred embodiments of the invention, it is also to be understood that the invention is not restricted to these particular embodiments rather, the invention includes all embodiments which are functional, or mechanical equivalents of the specific embodiments and features that have been described and illustrated herein.

It will be understood that, although various features of the invention have been described with respect to one or another of the embodiments of the invention, the various features and embodiments of the invention may be combined or used in conjunction with other features and embodiments of the invention as described and illustrated herein.

1. A high voltage proximity warning alarm system comprising a controller and at least one voltage proximity sensor mountable to a vehicle and in communication with the controller, wherein:
the controller has a user interface and at least one warning indicator which alerts a user when a voltage sensed by the at least one proximity sensor is above a user specified threshold value and
each of the at least one voltage proximity sensor has a sensor housing having a front surface and a back surface, the front surface having a sensor plate connected to a voltage sensor positioned in the housing, and the sensor housing having side surfaces connecting the front surface to the back surface, the side surfaces being chamfered as sloping outwardly from the front surface to the back surface when the sensor housing is viewed from a side view, the back surface being planar so as to be mountable flat against a planar surface of the vehicle.

2. The high voltage proximity warning alarm system of claim 1, wherein each of the at least one voltage proximity sensors is electrically connected to the controller by electrical cables.

3. The high voltage proximity warning alarm system of claim 1, wherein each of the at least one voltage proximity sensors has a sensor radio transmitter and receiver device and the controller has a controller radio transmitter and receiver device, so that the at least one voltage proximity sensor communicates wirelessly with the controller by radio transmission.

4. The high voltage proximity warning alarm system of claim 1, wherein the plate housing is made of a material selected from the group consisting of ultra high modular weight polyethylene, powder coated steel, polycarbonate, and acrylic.

5. The high voltage proximity warning alarm system of claim 1, wherein the warning indicator is selected from the group consisting of visual, audio, and combinations thereof.

6. A high voltage proximity warning alarm system comprising a controller and at least one voltage proximity sensor mountable to a vehicle and in communication with the controller, wherein:
the controller has a user interface and at least one warning indicator which alerts a user when a voltage sensed by the at least one proximity sensor is above a user specified threshold value and
each of the at least one voltage proximity sensor has a sensor housing having a front surface and a back surface, the front surface having a sensor plate connected to a voltage sensor positioned in the housing, and the sensor housing having side surfaces connecting the front surface to the back surface, the side surfaces being chamfered as sloping outwardly from the front surface to the back surface when the sensor housing is viewed from a side view, the back surface being planar so as to be mountable flat against a planar top surface of a sensor mounting plate which is fixed to a flat surface of the vehicle.
